(19) United States
(12) Patent Application Publication
(10) Pub. No.: US 2005/0185633 A1
(43) Pub. Date: Aug. 25, 2005

(54) Route control device and route control system

(76) Inventor: Hiroyuki Shigei, Kawasaki (JP)

Correspondence Address: KATTEN MUCHIN ROSENMAN LLP, 575 MADISON AVENUE, NEW YORK, NY, 10022-2585, US

(21) Appl. No.: 10/650,016

(22) Filed: Aug. 27, 2003

(30) Foreign Application Priority Data
Aug. 30, 2002 (JP) JP2002-254234

(51) Int. Cl. H04L 12/28; H04L 12/66

(52) U.S. Cl. 370/352; 370/401; 370/465

(57) ABSTRACT

A route control device disposed between a plurality of first devices and a second device for providing a service to the first devices, has a plurality of I/O units, to which the first devices are connected, inputting and outputting data to said first devices connected thereto, a service storage unit storing a service that should be provided from the second device to the first devices connecting to the I/O unit in a way that maps the service to each the I/O unit, a service determining unit searching through the service storage unit and thus determining the service that should be provided to the first devices connecting to anyone of the I/O units, and a service request unit requesting the second device to provide the service determined by the service determining unit to the first devices concerned.

### BACKGROUND OF THE INVENTION

The present invention relates to a route control device to which a plurality of network terminals are connected, and to a system for providing services about a network to the plurality of network terminals.

There has hitherto been a system in which a user receives a service from ISP (Internet Service Provider) Specifically, the user connects, by use of PPP (Point-to-Point Protocol), a self-possessed IP routing device (that supports Internet Protocol) to an edge router installed by the ISP.

At this time, the edge router authenticates the user. The edge router assigns an IP address to the IP routing device of the user who has been authenticated. Then, the IP routing device performs communications based on a service previously agreed upon between the user and the ISP by use of the assigned IP address.

This type of IP routing device is exemplified by a router. A plurality of IP devices are connected to this router. The IP devices connected to the router are exemplified such as a personal computer, and an IP telephone, a Television (ITTV) that support IP (Internet Protocol), and so on. The router receives a packet from the IP device connected to the router itself, then rewrites a header of this packet and forwards it to an edge router. Further, the router receives a packet from the edge router, then rewrites a header of this packet and forwards it to a proper IP device.

Examples of the services agreed upon between the user and the ISP are a fixed bandwidth assurance, a VPN (Virtual Private Network), multicasting, etc. . . .

### SUMMARY OF THE INVENTION

The user has hitherto been normally given one service selectable per connection line (contract line) contracted between the user and the ISP. Therefore, the user, in the case of receiving the service suited to the IP device to be used, needs to establish a contract with the ISP about the service suited to this IP device. For example, if the user receives the VPN service, there is only one VPN that the ISP enables the user to use. Consequently, the user is required to make a contract with the ISP each time the user connects to a different VPN corresponding to the IP device.

Accordingly, it is a primary object of the present invention, which was devised to obviate the above problems, to provide a route control device enabling a user to automatically receive a service suited to an IP device from an ISP edge router.

To accomplish the above object, according to a first aspect of the present invention, a route control device disposed between a plurality of first devices and a second device for providing a service to the first devices, includes a plurality of I/O modules, to which the first devices can be connected, inputting and outputting data to the first devices thereto, a service storage module storing a service that should be provided from the second device to the first devices connecting to the I/O module in a way that maps the service to each the I/O module, a service determining module searching through the service storage module and thus determining the service that should be provided to the first devices connecting to any one of the I/O modules, and a service request module requesting the second device to provide the service determined by the service determining module to the first devices concerned.

According to the first aspect of the present invention, the first devices are connecting to the I/O module. The service storage module stores, for every I/O module, the service provided from the second device to the first devices connecting to this I/O module. The service determining module searches through the service storage module and thus determines a service mapping to an arbitrary I/O module. Namely, the service determining module determines the service provided to the first devices connecting to the arbitrary I/O module. Then, the service request module requests the second device to provide the relevant first devices with the service determined by the service determining module.

With this scheme, the services mapping to the I/O modules to which the first devices are respectively connected, are automatically provided from the second device.

The route control device according to the first aspect of the invention may further includes a setting module setting a content stored on the service storage module in accordance with an input from the first devices.

In the route control device according to the first aspect of the invention, the setting module may provide the first devices with a user interface for setting content stored on the service storage module, and may set the content stored on the service storage module on the basis of data inputted via the user interface.

The route control device according to the first aspect of the invention may further include a link detection module detecting the I/O module with an established link to the first devices among the plurality of I/O modules, wherein the service determining module may determine the service that should be provided to the first devices connecting to the I/O module detected by the link detection module, and the service determining module and the service request module may operate when the link detection module detects the establishment of the link.

In the route control device according to the first aspect of the invention, the link detection module may further detect the I/O module of which the link established so far is disconnected, the service determining module may determine the service provided to the first devices connecting to the I/O module, and the service request module may request the second device to stop providing the service to the first devices.

The route control device according to the first aspect of the invention may further include a data detection module detecting the I/O module, to which the data is inputted from the first devices, among the plurality of I/O modules, wherein the service determining module may determine the service that should be provided to the first devices connecting to the I/O module detected by the data detection module, and the service determining module and the service request module may operate when the data detection module detects the input of the data.

In the route control device according to the first aspect of the invention, the data detection module may further detect the I/O module to which the data is not inputted for a fixed period of time, the service determining module may determine the service provided to the first devices connecting to the I/O module, and the service request module may request the second device to stop providing the service to the first devices.

In the route control device according to the first aspect of the invention, the service storage module may further store, for each of the I/O modules, information indicating which module, the link detection module or the data detection module, may control the operations of the service determining module and of the service request module with respect to the I/O module.

In the route control device according to the first aspect of the invention, the service storage module, if there is added information required with an execution of the service, may further store the added information in a way that maps the added information to the service.

In the route control device according to the first aspect of the invention, the service may include providing a VPN (Virtual Private Network), and the service storage module, when storing the virtual private network as a service, may store as the added information a user identifier and a password that are required for the first devices connecting to the I/O module mapping to this server to be connecting to the virtual private network.

In the route control device according to the first aspect of the invention, the service may include a best-effort service and a fixed bandwidth assurance service as QoS (Quality of Service).

The route control device according to the first aspect of the invention may further include a download module downloading a program for controlling an operation of a self-device from the second device.

According to a second aspect of the present invention, a route control system includes a plurality of first devices, a second device for providing a service to the first devices and a third device disposed between the first devices and the second device. The third device includes a plurality of I/O modules, to which the first devices are connected, inputting and outputting data to the first devices connected thereto, a first service storage module storing a service that should be provided from the second device to the first devices connecting to the inputting/outputting module in a way that maps the service to each the I/O module, a service determining module searching through the first service storage module and thus determining the service that should be provided to the first devices connecting to any one of the I/O modules, and a service request module requesting the second device to provide the service determined by the service determining module to the first devices concerned. The second device includes a second service storage module storing the service requested by the third device in a way that maps the service to the first devices, and a service execution module determining a relevant service for the first devices by searching through the second service storage module and thus determining the service.

In the route control system according to the second aspect of the invention, the second device may further include an authentication module authenticating the third device or a user of the third device on the basis of data received from the third device in cooperation with an authentication server, and the service execution module may execute the service about only the third device permitted as a result of the authentication.

In the route control system according to the second aspect of the invention, the service request module may request in a lump the second device to provide a plurality of services respectively to the first devices concerned.

In the route control system according to the second aspect of the invention, the second device may further include an accounting module charging the user of the first devices a fee for the service executed by the service execution module on the basis of a content of this service.

In the route control system according to the second aspect of the invention, the second device and the third device may be so connected as to be communicable via a communication line based on one point-to-point protocol, and the service request module may make a request for the service different for every session of Transmission Control Protocol.

According to the present invention, the services mapping to the I/O modules to which the first devices are connected can be automatically provided respectively for the plurality of first devices.

### BRIEF DESCRIPTION OF THE DRAWINGS

FIG. 1 is a view showing architecture of a system utilizing a router as a route control device in this embodiment;

FIG. 2 is a block diagram showing the router;

FIG. 3 is a diagram showing an example of a service table;

FIG. 4 is a diagram showing an example of a translation table;

FIG. 5 is a block diagram showing an edge router;

FIG. 6 is a diagram showing an example of the service table;

FIG. 7 is a flowchart showing an operational example of the router; and

FIG. 8 is a diagram showing an operation sequence of the system in this embodiment.

### DETAILED DESCRIPTION OF THE PREFERRED EMBODIMENTS

Next, a system using a route control device in an embodiment of the present invention will hereinafter be described with reference to the accompanying drawings. Note that the explanation of this embodiment is an exemplification, and architecture of the present invention is not limited to the following discussion.

[Outline of System]

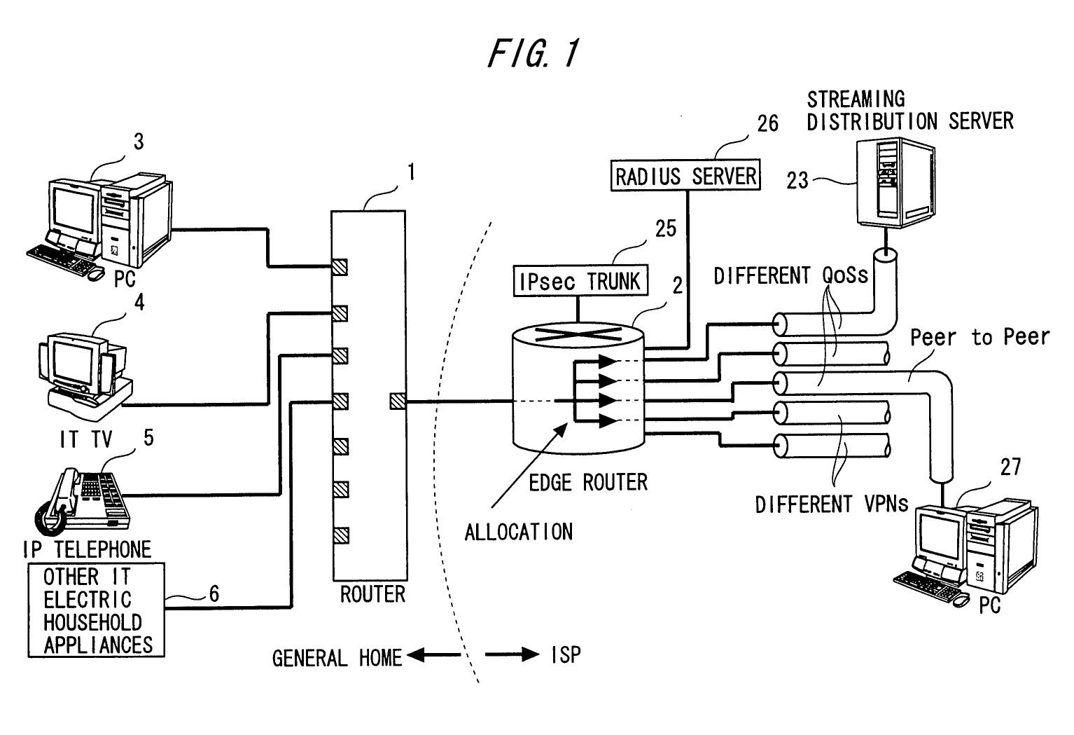

FIG. 1 is a view illustrating system architecture of the system using a router defined as a route control device in the embodiment of the present invention. According to this system, devices installed in a general home are a router 1. Further, according to this system, a personal computer (PC) 3, an ITTV 4, an IP telephone and other IT electric household appliances 6 which are connected downstream of the router 1. Further, in this system, an edge router 2, a streaming distribution server 23, an IPsec (IP security) trunk 25, a RADIUS (Remote Authentication Dial-In User Service) server 26 and an unillustrated core router, which are installed based on ISP. The followings are explanations of the respective components.

<Router>

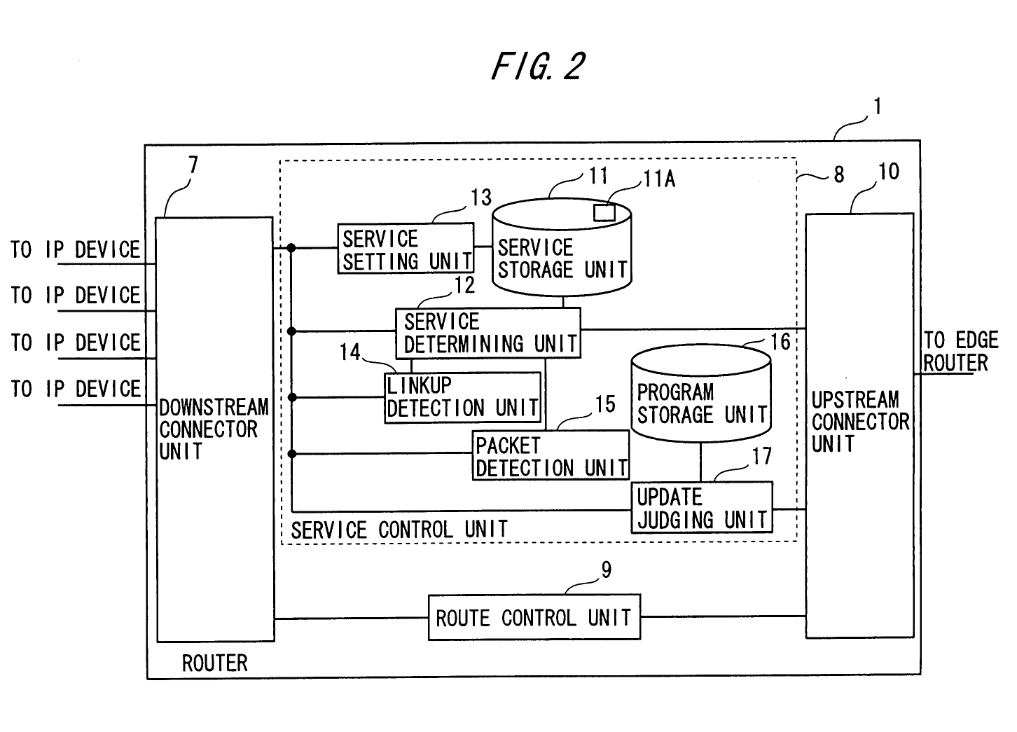

The router 1 is constructed of an IP-based router (corresponding to a [route control device] and a [third device] according to the present invention). FIG. 2 is a block diagram of the router 1 as the route control device in the embodiment of the present invention. The router 1 includes hardware components such as a CPU, a main memory (RAM), a sub-storage device, an acceptable connector, a PHY chip (physical layer chip) and a switch chip, which are connecting to each other via a bus. The router 1, when various categories of programs stored on the sub-storage device (especially on a program storage unit 16) are loaded into the main memory and executed by the CPU, functions as a device including a downstream connection unit 7, a service control unit 8, a route control unit 9 and an upstream connector unit 10. The router 1 is a so-called [consumer router] or [domestic router] and installed in home. This type of consumer router is exemplified such as an ADSL (Asymmetrical Digital Subscriber Line) router, an ISDN (Integrated Services digital Network) router and so forth.

The downstream connector unit 7 is constructed of a plurality of acceptable connectors and PHY chips. The plurality of acceptable connectors (corresponding to an [I/O module] according to the present invention) may involve the use of any types of connectors such as a T-type connector, RJ-45 (Registered Jack-45), etc. . . . Further, the PHY chip may be based on whatever specifications such as 10BASE2 (LAN interface having a transmission rate of 10 Mbps, defined by IEEE802.3), 100BASE-T (100 Mbps) and so on. The PHY chip and the acceptable connector are, however, constructed of those corresponding to the same specifications. The connector unit 7 transmits and receives the data between the router 1 and the IP device (the PC 3, the ITTV 4, the IP telephone 5, etc.) connected to the router 1.

The service control unit 8 is constructed of a CPU, a RAM and a nonvolatile storage device. The service control unit 8 includes a service storage unit 11, a service determining unit 12, a service setting unit 13, a linkup detection unit 14, a packet detection unit 15, a program storage unit 16 and an update judging unit 17.

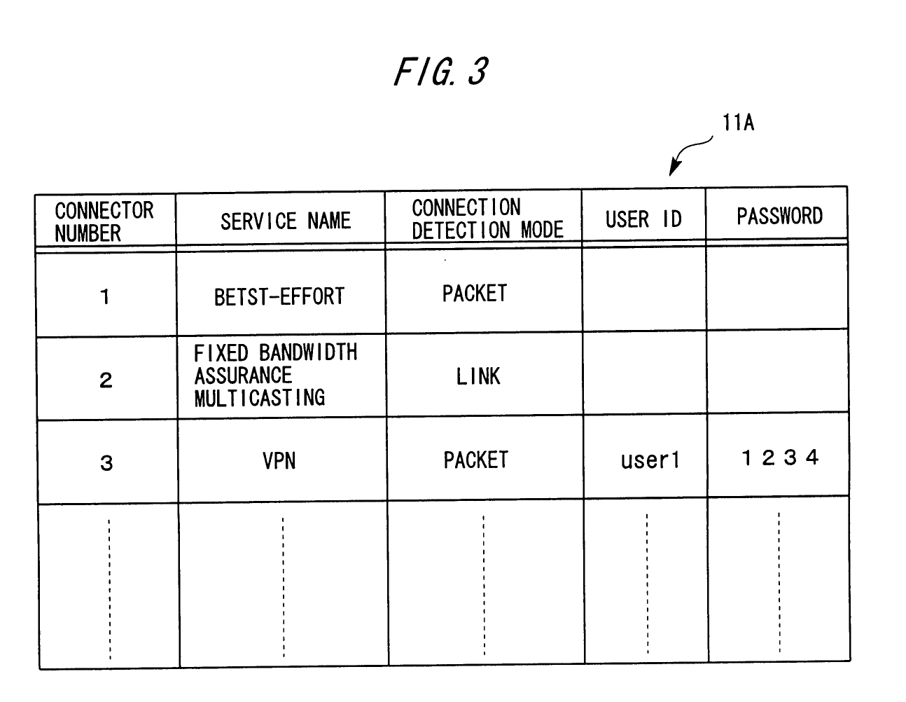

The service storage unit 11 is constructed of a nonvolatile storage device such as a flash memory, etc. (corresponding to a [service storage module] and a [first service storage module] according to the present invention). The service storage unit 11 is stored with user IDs and passwords which are used for authentication in the edge router 2. Further, the service storage unit 11 is stored with a service table 11A. FIG. 3 is a diagram showing an example of the service table 11A stored on the service storage unit 11. The service table 11A will be explained referring to FIG. 3. The service table 11A retains pieces of information registered in fields such as a connector number, a service name, a connection detection mode, a user ID and a password, which are mapped to each other.

The connector number is a number assigned uniquely to each acceptable connector provided in the downstream connector unit 7. The connection detection mode takes a value of any one of categories “packet” and “link”. If the connection detection mode is “packet”, this implies that a packet is inputted to the acceptable connector, and a service corresponding thereto is requested of the edge router 2. Namely, when the packet is inputted via this acceptable connector for the first time after a packet receipt timeout, the service corresponding thereto is requested of the edge router 2. Herein, the “packet receipt timeout” indicates a state where the packet is not inputted to a certain acceptable connector for a fixed or longer period of time. By contrast, if the connection mode is the “link”, when a linkup between this acceptable connector and the IP device is detected, this implies that a corresponding service is requested of the edge router 2.

The service name is a name of the service provided to the IP device. Herein, the “IP device” indicates an IP device connected to the acceptable connector assigned the connector number mapping to the service name. Further, herein the “service provided” indicates a service provided to the ISP edge router 2. The user ID and the password are pieces of information (corresponding to [added information] according to the present invention) set in a case where authentication (that uses the user ID and the password) is required in the service specified by the service name mapping thereto.

For instance, according to the service table 11A shown in FIG. 3, the IP device connected to the acceptable connector of which a connector number is “3” is provided with VPN (Virtual Private Network) as a service. At this time, the user ID used for this VPN is “user1”, and the password is “1234”.

The service determining unit 12 (corresponding to a [service determining module] and [a service request module]) according to the present invention) is constructed of a CPU, a RAM, etc. . . . The service determining unit 12, when receiving the packet from the downstream connector unit 7, judges a connector number mapping to the acceptable connector to which the packet is inputted. The service determining unit 12, based on the connector number acquired as a result of the judgement, searches through the service table 11A stored on the service storage unit 11. Then, the service determining unit 12 determines a service requested of the edge router 2. The service determining unit 12 generates a service request signal for requesting the edge router 2 for the determined service, and transmits this service request signal to the edge router 2 via the upstream connector unit 8. The service request signal contains a service content requested, and a user ID and/or a password as the necessity may arise. Further, c the service request signal contains a post-translation port number. This post-translation port number is a post-translation port number assigned to the IP device connected to the acceptable connector mapping thereto. A detailed content of the post-translation port number will be given later on. Further, the service determining unit 12, for requesting the edge router 2 to connect the router to the edge router 2, transmits a connection request signal to the edge router 2. The connection request signal contains a user ID and a password stored on the service storage unit 11.

Moreover, the service determining unit 12, when notified of the connector number mapping to the acceptable connector with the link released or the packet that is not received for the fixed or longer period of time, requests the edge router 2 to stop a service mapping to this connector number.

The service setting unit 13 (corresponding to a [setting module] according to the present invention) is constructed of a CPU, a RAM, etc. . . . The service setting unit 13 writes, based on data received from the downstream connector unit 7, the contents of the service table 11A stored on the service storage unit 11.

To be specific, the service setting unit 13 implements a Web server function and provides, based on HTTP (HyperText Transfer Protocol), a user interface (UI) (that is a set content) to the IP device connected to the downstream connector unit 7. At this time, the IP device connected to the downstream connector unit 7 is a device capable of utilizing a Browser that supports HTTP. Further, at this time the UI provided by the service setting unit 13 is used for rewriting the contents of the service table 11A on the IP device. The service setting unit 13 may receive, for every acceptable connector, the rewritten contents of the service table 11A from the IP device and may also receive a set of rewritten contents for a plurality of acceptable connectors at one time.

Further, the service setting unit 13, when requested to change the service with respect to the acceptable connector through which the communications are being performed, does not reflect a content of this change in the service table 11A. In this case, the service setting unit 13 notifies the edge router 2 of the content of this change via the service determining unit 12. Namely, in this case, the service determining unit 12 generates a service request signal based on the change content received from the service setting unit 13, and transmits this signal to the edge router 2.

The linkup detection unit 14 (corresponding to a [link detection module] according to the present invention) is constructed of a CPU, a RAM, etc. . . . The linkup detection unit 14 detects a linked-up acceptable connector among the acceptable connectors provided in the downstream connector unit 7. The linkup detection unit 14, upon detecting the linked-up acceptable connector, notifies the service determining unit 12 of a connector number mapping to this acceptable connector. Then, the linkup detection unit 14 instructs the service determining unit 12, to request the edge router 2 to provide a service mapping to the connector number of the acceptable connector.

Further, the linkup detection unit 14 detects a link-released acceptable connector. Then, the linkup detection unit 14 notifies the service determining unit 12 of a connector number mapping to this link-released acceptable connector.

The packet detection unit 15 (corresponding to a [data detection module] according to the present invention) is constructed of a CPU, a RAM, etc. . . . The packet detection unit 15 detects an acceptable connector to which the packet is inputted for the first time after a packet receipt timeout, among the acceptable connectors provided in the downstream connector unit 7. The packet detection unit 15, upon detecting an acceptable connector receiving the packet, notifies the service determining unit 12 of a connector number mapping to this acceptable connector. Then, the packet detection unit 15 instructs the service determining unit 12 to request the edge router 2 to provide a service mapping to a connector number of this acceptable connector.

Moreover, the packet detection unit 15 detects an acceptable connector that does not receive a new packet for the fixed or longer period of time. Namely, the packet detection unit 15 detects the acceptable connector falling into the packet receipt timeout. Then, the packet detection unit 15 notifies the service determining unit 12 of a connector number mapping to this acceptable connector.

The program storage unit 16 is constructed of a nonvolatile storage device such as a flash memory, etc. . . . The program storage unit 16 is stored with a program (an application program) described about the operation of the service control unit 8. Accordingly, the service determining unit 12, the service setting unit 13, the linkup detection unit 14, the packet detection unit 15 and the update judging unit 17 accesses the program storage unit 16 via the unillustrated bus, then read commands therefrom and thus function.

The update judging unit 17 is constructed of a CPU, a RAM, etc. . . . The update judging unit 17 judges whether the program stored on the program storage unit 16 should be updated or not. The update judging unit 17, when an update command is inputted from the IP device via the downstream connector unit 7, judges that the program should be updated. Further, the update judging unit 17, when the update command is inputted from the edge router 2 via the upstream connector unit 10, judges that the program should be updated. Moreover, the update judging unit 17, if a predetermined time has elapsed, judges that the program should be updated. The update judging unit 17, when judging that the program should be updated, requests the edge router 2 to start downloading through the upstream connector unit 10. The program is downloaded into the update judging unit 17 from the edge router 2 via the upstream connector unit 10. Then, the update judging unit 17 updates the program stored on the program storage unit 16 by use of the program downloaded.

The route control unit 9 is constructed of a CPU, a RAM, a switch chip, etc. . . . The route control unit 9 has the same functions as those of the conventional router and the layer-3 switch. Namely, the route control unit 9 receives the packet from the downstream connector unit 7 and reads header information contained in this packet. The route control unit 9 changes, based on the readout header information and a self-retained routing table, the header information of this packet. Then, the route control unit 9 forwards this packet to the edge router 2 via the upstream connector unit 10. Further, the route control unit 9 performs the same route control for the packet received from the upstream connector unit 10, and forwards this packet to a proper IP device via the downstream connector unit 7.

Moreover, the route control unit 9 functions as a DHCP (Dynamic Host Configuration Protocol) server. To be specific, the route control unit 9 assigns a local IP address (a private IP address) to each of the IP devices connected to the downstream connector unit 7.

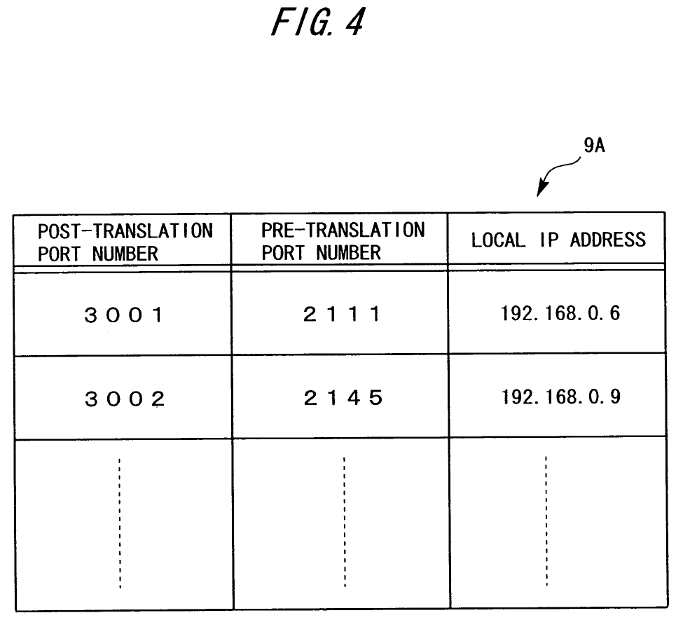

Further, the route control unit 9 has an IP masquerade function. The route control unit 9 identifies a source IP device that transmits the packet received via the downstream connector unit 8 by use of a translation table 9A. FIG. 4 is a diagram showing an example of the translation table 9A. The translation table 9A will b e explained referring to FIG. 4. The translation table 9A is stored with a source port number (a pre-translation port number) and a source IP address (a local IP address) that are contained in a header of the packet transmitted from each of the IP devices, and a port number (a post-translation port number) assigned to each of the IP devices in a way that makes these items of data mapping to each other. The route control unit 9 rewrites a value of the source port number contained in the header of the packet received from each of the IP devices into the post-translation port number. Further, the route control unit 9 refers to a destination port number contained in the header of the packet received from the edge router 2, and searches through the translation table to acquire a pre-translation port number mapping to the post-translation port number coincident with this destination port number. Then, the route control unit 9 replaces the destination portion number contained in the packet header with the pre-translation port number searched from the table 9A.

The upstream connector unit 10 is constructed of one or more acceptable connectors and PHY chips, etc. . . . The upstream connector unit 10 is configured in accordance with an environment of the network to which the router 1 is connected. The network in this category may be exemplified such as a leased line, ADSL, LSDN and so on. The upstream connector unit 10 transmits and receives the data between the router 1 and the edge router 2.

<Edge Router>

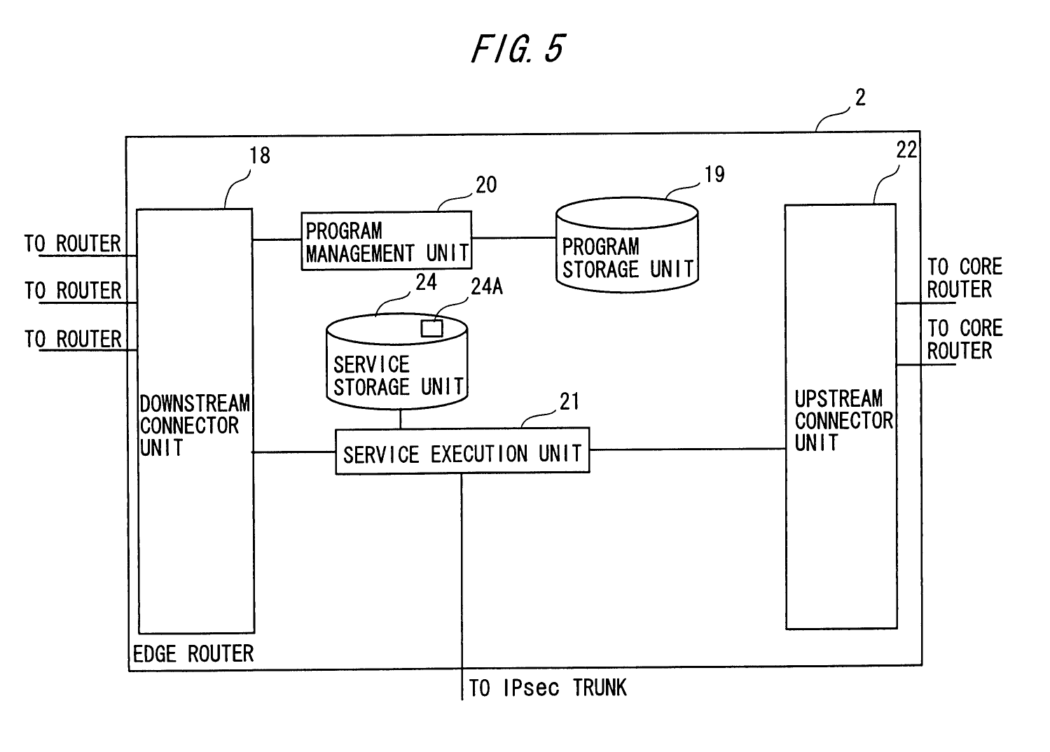

The edge router 2 (corresponding to a [second device] according to the present invention) is constructed of an IP-based router. FIG. 5 is a block diagram of the edge router 2 in the embodiment of the present invention. The edge router 2 includes hardware components such as a CPU, a main memory (RAM), a sub-storage device, an acceptable connector, a PHY chip and a switch chip, which are connected to each other via a bus. The edge router 2, when various categories of programs stored on the sub-storage device are loaded into the main memory and executed by the CPU, functions as a device including a downstream connection unit 18, a program storage unit 19, a program management unit 20, a service executing unit 21, an upstream connector unit 22 and a service storage unit 24.

The downstream connector unit 18 is constructed of a plurality of acceptable connectors and PHY chips (physical chips). The downstream connector unit 18 is configured in accordance with a network to which the edge router 2 is connected. The downstream connector unit 18 transmits and receives the data between the edge router 2 and the router 1.

The program storage unit 19 is constructed of a nonvolatile storage device such as a flash memory, a hard disk, etc. . . . The program storage unit 19 is stored with a program (an application program) used on the router 1. The program storage unit 19 is stored with programs corresponding to plural types of routers 1.

The program management unit 20 is constructed of a CPU, a RAM, etc. . . . The program management unit 20, upon detecting that the program on the program storage unit 19 is updated afresh, sends an update command to the router 1 of the type corresponding to this updated program. Further, the program management unit 20, when the router 1 makes a request for downloading, reads the program corresponding to the type of this router 1 from the program storage unit 19. Then, the program management unit 20 transmits the readout program to the router 1 via the downstream connector unit 18.

The service execution unit 21 (corresponding to a [service executing module] according to the present invention) is constructed of a CPU, a RAM, a switch chip, etc. . . . The service execution unit 21 executes the route control about the packets inputted from the downstream connector unit 18 and the upstream connector unit 22. Further, the service execution unit 21, when receiving a service request signal from the router 1, changes a service table 24A on the basis of a content of this service request signal.

Moreover, the service execution unit 21 provides the router 1 with a service requested by the router 1. Namely, the service execution unit 21 controls a line disposed upstream of the upstream connector unit 22 in accordance with the service requested by the router 1. The services of these categories are fixed bandwidth assurances, multicasting, VPN, etc. . . . Further, the service execution unit 21, when requested by the router 1 to stop the service, stops the execution of the service concerned.

The upstream connector unit 22 is constructed of one or more acceptable connectors and PHY chips. The upstream connector unit 22 is configured corresponding to the environment of the network to which the edge router 2 is connected. The networks of this category are exemplified such as gigabit Ethernet, MAPOS (Multiple Access Protocol over SONET/SDH (Synchronous Optical Digital Network/Synchronous Digital Hierarchy)) and so on. The upstream connector unit 22 transmits and receives the data between the edge router 2 and the ISP core router to which this edge router 2 belongs.

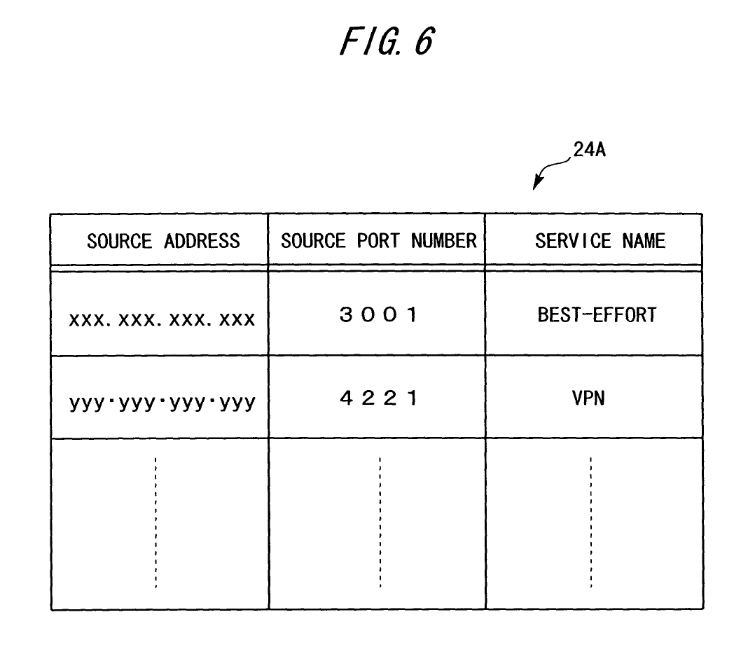

The service storage unit 24 (corresponding to a [second service storage module] according to the present invention) are constructed of a RAM, etc. . . . The service storage unit 24 is stored with a service table 24A. FIG. 6 is a diagram showing an example of the service table 24A. The service table 24A will be explained referring to FIG. 6. The service table 24A is stored with a source address (a source IP address), a source port number and a service name in a way that makes these items of information mapping to each other. This source address is a value of the source address contained in the packet header and defined as a global IP address assigned to the router 1 that transmits this packet. The source port number is a source port number contained in the packet header and also a value replaced by the router 1 that transmits this packet. Namely, this source port number corresponds to the post-translation port number in the translation table 9A. Accordingly, a service mapping to the source address and the source port number contained in the header of the packet inputted to the edge router 2, is searched for in the service table 24A. Then, the service searched for is executed with respect to this packet. This process is called “filtering”.

<PC>

Referring back to FIG. 1, the PC3 has a display device, an input device and a communication control device in addition to the main body including the central processing unit, the main memory, etc. . . . The PC3 is so connected as to be communicable with the router 1 through the network. The PC 3 is installed with a Web Browser. Therefore, the user can set the router 1 by use of the Web Browser on the PC 3. Namely, the user can set contents of the service table 11A through the service setting unit 13 by use of the PC 3.

<ITTV>

The ITTV 4 is a television (TV) including the communication control device and is so connected as to be communicable with the router 1 via the network. The ITTV 4 receives picture data from the streaming distribution server 23 installed based on ISP, and displays the data as a picture. At this time, the stable streaming distribution is actualized by selecting a fixed bandwidth assurance service.

<IP Telephone>

The IP telephone 5 is a telephone including the communication control device and is so connected as to be communicable with the router 1 via the network. The IP telephone 5 encodes a voice inputted and packetizes the encoded data into an IP packet. Then, the IP telephone 5 sends the thus generate IP packet to the router 1. Further, the IP telephone 5 receives the packet from the router 1 and reproduces a voice from this packet.

<Other IT Electric Household Appliances>

Other IT electric household appliances 6 are IT electric household appliances different from the ITTV and the IP telephone and are, for instance, an IT microwave oven, an IT electric water heater. The IT electric household appliance 6 includes the communication control device and is so connected as to be communicable with the router 1 via the network. The IT electric household appliance 6 receives the packet from the router 1 ad processes the packet received. Further, the IT electric household appliance 6 assembles a packet and sends the packet to the router 1.

<Streaming Distribution Server>

The streaming distribution server 23 is constructed of a PC, a workstation, etc. . . . The streaming distribution server 23 distributes music data and picture data encoded based on the streaming technology t the IP device via the network. The streaming distribution server 23 may store a self-installed hard disk with previously-encoded music data and picture data or with the music data and the picture data before being encoded. In the latter case, the encoding process is executed in parallel with the distribution process. This hard disk may be, however, provided separately from the streaming distribution server 23.

<IPsec Trunk>

The IPsec trunk 25 is constructed of a PC, a workstation, etc. . . . The IPsec trunk 25, when the VPN service is carried out in the edge router 2, executes processes necessary for actualizing VPN. To be specific, the IPsec trunk 25 receives from the edge router 2 the packet to be forwarded to VPN, and encrypts and encapsulates this packet. Further, the IPsec trunk 25 receives from the edge router 2 the packet received from VPN, and decapsulates and decrypts this packet.

<RADIUS Server>

The RADIUS server 26 is constructed of a PC, a workstation, etc. . . . The RADIUS server 26 permits or rejects the access on the basis of the user ID and the password. Further, the RADIUS server 26 gathers pieces of data called attributes such as a connection time, inputted/outputted packet sizes, a callback ID and a port number used.

[Operational Example]

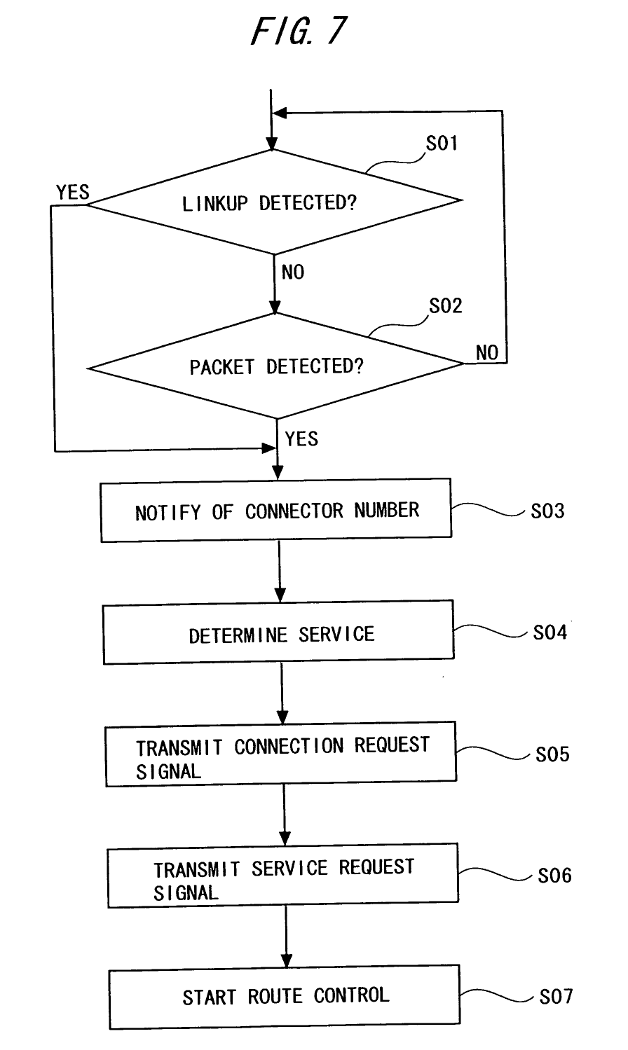

FIG. 7 is a flowchart showing an operational example when the router 1 sends a service request to the edge router 2. The operational example of the router 1 will be described referring to FIG. 7.

To start with, the linkup detection unit 14 detects whether or not there is a linked-up acceptable connector among the acceptable connectors provided in the downstream connector unit 7 (S01). Further, the packet detection unit 15 detects whether or not there is an acceptable connector having received the packet among the acceptable connectors provided in the downstream connector unit 7 (S02). The linkup detection unit 14, when detecting the linkup (S01—YES), notifies the service determining unit 12 of a connector number mapping to the acceptable connector with the linkup detected (S03). The packet detection unit 15, when detecting the receipt of the packet (S02—YES), notifies the service determining unit 12 of a connector number mapping to the acceptable connector with the packet receipt detected (S03).

The service determining unit 12 searches for and determines a service mapping to the notified connector number in the service table 11A (S04). The service determining unit 12 reads from the service storage unit 11 a user ID and a password used for authentication on the edge router 2, and generates a connection request signal. Then, the service determining unit 12 transmits the connection request signal to the edge router 2 via the upstream connector unit 10 (S05). The service determining unit 12, when the router 1 is connected to the edge router 2, generates a service request signal and transmits this service request signal to the edge router 2 (S06). Then, the route control unit 9 starts the route control (S07).

[Operation Sequence]

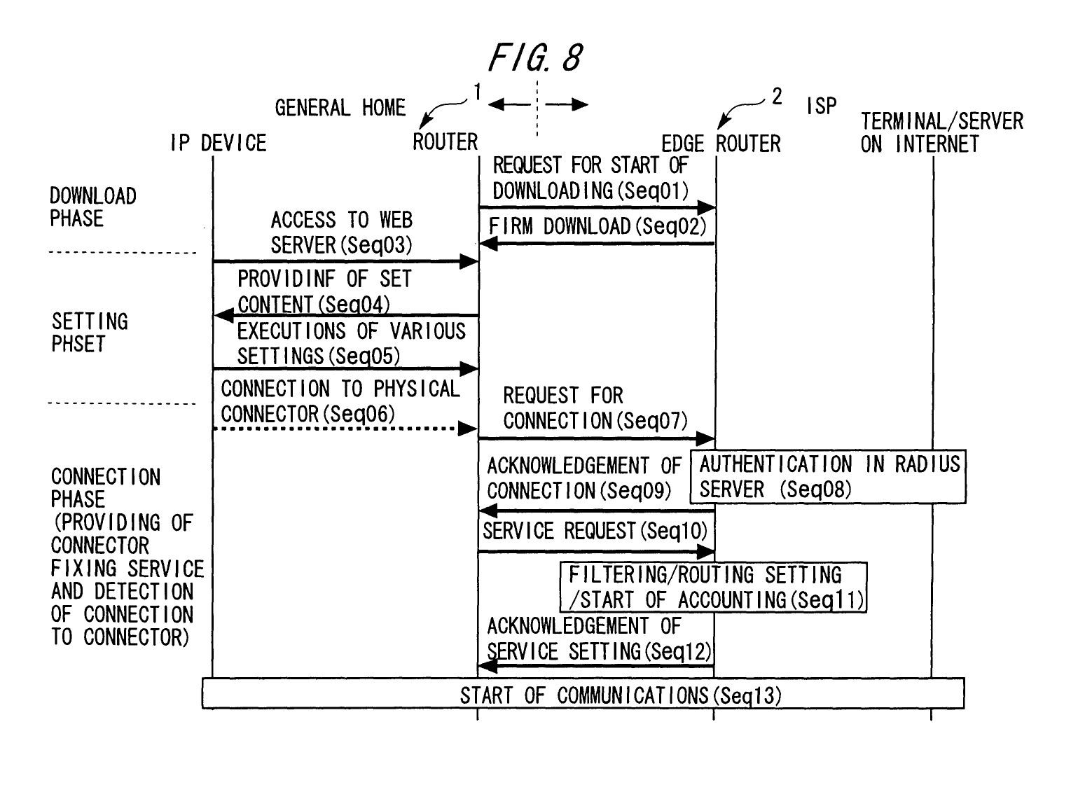

FIG. 8 is a diagram showing an operation sequence of the system in this embodiment. The system operation sequence in this embodiment consists of a download phase, a setting phase and a connection phase. The following is a discussion on the operation sequence in the respective phases.

<Download Phase>

The download phase is that the router 1 downloads, from the program storage unit 16, the application program stored thereon in the edge router 2. At this time, the router 1 requests the edge router 2 to start downloading (Seq01). The edge-router 2, upon receiving this request, transmits the application program to the router 1 concerned (Seq02).

<Setting Phase>

According to the setting phase, the user sets the service table 11A provided in the router 1 by use of the IP device. At this time, it is desirable that the user utilizes the IP device including the I/O device such as a display, a keyboard, etc. as in the case of the PC 3. Therefore, the following discussion will deal with a case where the user sets the service table 11A through on the PC 3.

The user accesses the Web server function installed in the router 1. Namely, the user accesses the service setting unit 13 through on the PC 3 (Seq03). Then, the router 1 (the service setting unit 13) provides a set content to the PC 3 (Seq04). The set content is a user interface (UI) used for the user to set the service table 11A. The user sets the service table 11A by utilizing this user interface through on the PC 3 (Seq05).

<Connection Phase>

The connection phase is that the edge router 2 provides a service corresponding to each of the IP devices. To begin with, the IP device is connected to the router 1 (Seq06). Alternatively, the IP device sends the packet to the router 1. Then, the router 1 transmits the connection request signal containing the user ID and the password to the edge router 2 (Seq07). The edge router 2 transfers the received user ID and password to the RADIUS server 26, and requests the RADIUS server 26 to authenticate. The RADIUS server 26 authenticates the user by use of the received user ID and password (Seq08). Then, the RADIUS server 26 sends a result of the authentication to the edge router 2. The edge router 2 executes a process of assigning a global IP address as a connection acknowledgement to the router 1 with the user authenticated, and so on (Seq09).

Next, the router 1 determines a service mapping to the acceptable connector (port) connected. Then, the router 1 transmits a service request signal about the determined service to the edge router 2 (Seq10). The edge router 2, when receiving the service request signal, executes service setting (for filtering and routing) (Seq11). Namely, the edge router 2 starts, in cooperation with the RADIUS server 26, an accounting process for the router 1. The accounting process is executed on a variety of bases such as a packet count of the packets across the edge router 2, a connection time and so forth. Then, the edge router 2 notifies the router that the service is started as a service setting acknowledgement (Seq12). Thus, the communications among the IP device, the router 1, the edge router 2 and the terminal/server on the Internet are started (Seq13).

[Operation and Effect]

According to this embodiment, the user sets the service to be provided for every acceptable connector through on the PC 3. The service determining unit 12 searches for the service set for the acceptable connector to be used, and request the edge router 2 for this service. Therefore, the edge router 2 provides the services different for each of the acceptable connectors included in the router 1. Accordingly, the following services can be actualized.

Firstly, a different QoS class (Quality of Service class) can be set for each of the acceptable connectors of the router 1 with respect to the line used within the ISP network. For instance, a the QoS class of a best-effort service is provided to the IP device connected to a certain acceptable connector, while the QoS class of the fixed bandwidth assurance is provided to the IP device connected to other acceptable connector.

Secondly, the plurality of IP devices can be connected respectively to different VPNs by use of one single contract line with the ISP. For example, the IP device connected to a certain acceptable connector is provided with VPN for connection to LAN in a company A, while the IP device connected to other acceptable connector is provided with VPN for connection to LAN in a university B.

Further, the fixed bandwidth assurance and multicasting are selected for the acceptable connector to which, e.g., the ITTV 4 is connected, and it is desirable that the category “link” be selected as a connection detection mode. These services are selected to the ITTV 4, whereby the router 1 detects the linkup when switching ON the power source of the ITTV 4. Then, the user can receive, at the QoS class of the fixed bandwidth assurance, the picture distributed from the streaming distribution server 23 within the ISP network.

Moreover, the user is able to arbitrarily change the service mapping to the connector number of an arbitrary acceptable connector by use of the IP device (e.g., the PC3). Therefore, as for the IP device having no I/O interface, the service mapping to the connector number of the acceptable connector to which this IP device is connected, can be set by use of the IP device (e.g., the PC 3) having other I/O interface. Moreover, what is described as below can therefore be carried out. To be specific, the PC 3 is normally connected to the acceptable connector receiving the best-effort service and can be changed to temporarily receive the service of the fixed bandwidth assurance without changing the acceptable connector for connection. This scheme is effective in a case where, for instance, a peer-to-peer connection with other PC is established, and a one-to-one game is performed, and so on.

Further, the router 1 requests the edge router 2 for a necessary service each time. Accordingly, the edge router 2 has no necessity of standby always for providing the router 1 with the service that should be provided. Namely, the edge router 2 may be stored with the respective settings of filtering and routing about only the services requested of the router 1. Hence, the respective setting entries for filtering and routing can be saved.

[Modified Example]

The downstream connector unit 7 may be configured in whatever modes on condition that its configuration supports LAN (Local Area Network) or a system corresponding to LAN. Moreover, the upstream connector unit 10 may be configured in whatever modes on condition that its configuration supports WAN (Wide Area Network) or a system corresponding to WAN.

Further, the service determining unit 12 may be configured to prompt the user to select the service to be executed without referring to the service table 11A stored on the service storage unit 11.

In this case, the IP device can receive the service that is different each time in the same acceptable connector without the service being fixed to the connector number.

Furthermore, the service determining unit 12 may be configured to prompt the user to select the service with respect to only an arbitrary acceptable connector and to reflect the contents of the service table 11A with respect to other acceptable connector.

Moreover, the service table 11A may be structured to store a MAC (Media Access Control) address of the IP device as a substitute for the connector number. Namely, the service table 11A may be structured to store a service name, a connection detection mode, a user ID and a password for every MAC address of the IP device. In this case, the service determining unit 12 searches through the service table 11A in a way that refers to the MAC address contained in the packet inputted from the downstream connector unit 7.

Further, the edge router 2 may be configured to include an encrypting module, thereby providing an encryption service. More specifically, the edge router 2 may be configured to, if the encryption service is selected for the packet received from the router 1, encrypt this packet and forward the encrypted packet to the core router.

1. A route control device which can be disposed between a plurality of first devices and a second device for providing a service to said first devices, comprising:
a plurality of I/O modules, to which said first devices can be connected, inputting and outputting data to said first devices thereto;
a service storage module storing a service that should be provided from said second device to said first devices connecting to said I/O module in a way that maps the service to each said I/O module;
a service determining module searching through said service storage module and thus determining the service that should be provided to said first devices connecting to any one of said I/O modules; and
a service request module requesting said second device to provide the service determined by said service determining module to said first devices concerned.

2. A route control device according to claim 1, further comprising a setting module setting a content stored on said service storage module in accordance with an input from said first devices.

3. A route control device according to claim 2, wherein said setting module provides said first devices with a user interface for setting a content stored on said service storage module, and sets the content stored on said service storage module on the basis of data inputted via said user interface.

4. A route control device according to any one of claims 1 through 3, further comprising a link detection module detecting said I/O module with an established link to said first devices among said plurality of I/O modules,
wherein said service determining module determines the service that should be provided to said first devices connecting to said I/O module detected by said link detection module, and
said service determining module and said service request module operate when said link detection module detects the establishment of the link.

5. A route control device according to claim 4, wherein said link detection module further detects said I/O module of which the link established so far is disconnected,
said service determining module determines the service provided to said first devices connecting to said I/O module, and
said service request module requests said second device to stop providing the service to said first devices.

6. A route control device according to claim 4 or 5, further comprising a data detection module detecting said I/O module, to which the data is inputted from said first devices, among said plurality of I/O modules,
wherein said service determining module determines the service that should be provided to said first devices connecting to said I/O module detected by said data detection module, and
said service determining module and said service request module operate when said data detection module detects the input of the data.

7. A route control device according to claim 6, wherein said data detection module further detects said I/O module to which the data is not inputted for a fixed period of time,
said service determining module determines the service provided to said first devices connecting to said I/O module, and
said service request module requests said second device to stop providing the service to said first devices.

8. A route control device according to claim 6 or 7, wherein said service storage module further stores, for each of said I/O modules, information indicating which module, said link detection module or said data detection module, controls the operations of said service determining module and of said service request module with respect to said I/O module.

9. A route control device according to any one of claims 1 through 8, wherein said service storage module, if there is added information required with an execution of the service, further stores the added information in a way that maps the added information to the service.

10. A route control device according to claim 9, wherein the service includes providing a VPN (Virtual Private Network), and
said service storage module, when storing the virtual private network as a service, stores as the added information a user identifier and a password that are required for said first devices connecting to said I/O module mapping to this server to be connecting to said virtual private network.

11. A route control device according to any one of claims 1 through 10, wherein the service includes a best-effort service and a fixed bandwidth assurance service as QoS (Quality of Service).

12. A route control device according to any one of claims 1 through 11, further comprising a download module downloading a program for controlling an operation of a self-device from said second device.

13. A route control system comprising:
a plurality of first devices, a second device for providing a service to said first devices and a third device disposed between said first devices and said second device,
said third device including:
a plurality of I/O modules, to which said first devices are connected, inputting and outputting data to said first devices connected thereto;
a first service storage module storing a service that should be provided from said second device to said first devices connecting to said inputting/outputting module in a way that maps the service to each said I/O module;
a service determining module searching through said first service storage module and thus determining the service that should be provided to said first devices connecting to any one of said I/O modules; and
a service request module requesting said second device to provide the service determined by said service determining module to said first devices concerned, said second device including:
a second service storage module storing the service requested by said third device in a way that maps the service to said first devices; and
a service execution module determining a relevant service for said first devices by searching through said second service storage module and thus determining the service.

14. A route control system according to claim 13, wherein said second device further includes an authentication module authenticating said third device or a user of said third device on the basis of data received from said third device in cooperation with an authentication server, and
said service execution module executes the service about only said third device permitted as a result of the authentication.

15. A route control system according to claim 13 or 14, wherein said service request module requests batchwise said second device to provide a plurality of services respectively to said first devices concerned.

16. A route control system according to claim 14, wherein said second device further includes an accounting module charging the user of said first devices a fee for the service executed by said service execution module on the basis of a content of this service.

17. A route control system according to claim 13, wherein said second device and said third device are so connected as to be communicable via a communication line based on one point-to-point protocol, and
said service request module makes a request for the service different for every session of Transmission Control Protocol.
